(19) United States
(12) Patent Application Publication
(10) Pub. No.: US 2026/0301234 A1
(43) Pub. Date: Oct. 1, 2026

(54) DYNAMIC MESH BASE GEOMETRY POSITION PREDICTION CODING

(71) Applicant: GUANGDONG OPPO MOBILE TELECOMMUNICATIONS CORP., LTD., Dongguan (CN)

(72) Inventors: Vladyslav Zakharchenko, Dongguan (CN); Yue Yu, Dongguan (CN); Haoping Yu, Dongguan (CN)

(21) Appl. No.: 19/694,008

(22) Filed: Jun. 1, 2026

Related U.S. Application Data
(63) Continuation of application No. PCT/CN2024/127901, filed on Oct. 28, 2024.
(60) Provisional application No. 63/609,302, filed on Dec. 12, 2023.

(51) Int. Cl. G06T 9/00

(52) U.S. Cl. CPC G06T 9/001

(57) ABSTRACT

A method of decoding by a decoder is provided. The method includes that: a first syntax element is decoded from a bitstream to determine a base mesh; a second syntax element is decoded from the bitstream to determine whether additional prediction candidates for parallelogram-prediction coding is enabled for the base mesh; in response to additional prediction candidates for parallelogram-prediction coding being enabled for the base mesh, a third syntax element is decoded from the bitstream to determine a parallelogram-prediction coding mode from among a plurality of parallelogram-prediction coding modes for decoding the bitstream; a fourth syntax element is decoded from the bitstream to determine a position offset associated with the parallelogram-prediction coding mode; and the bitstream is decoded based on the parallelogram-prediction coding mode and the position offset.

### CROSS-REFERENCE TO RELATED APPLICATIONS

This is a continuation application of International Patent Application No. PCT/CN2024/127901, filed on Oct. 28, 2024, which claims the benefit of priority to U.S. Provisional Application No. 63/609,302, filed Dec. 12, 2023, entitled “DYNAMIC MESH BASE GEOMETRY POSITION PREDICTION CODING,” both of which are incorporated herein by reference in their entireties.

### BACKGROUND

Embodiments of the present disclosure relate to point cloud coding.

Point clouds are one of the major three-dimension (3D) data representations, which provide, in addition to spatial coordinates, attributes associated with the points in a 3D world. Point clouds in their raw format require a huge amount of memory for storage or bandwidth for transmission. Furthermore, the emergence of higher resolution point cloud capture technology imposes, in turn, even a higher requirement on the size of point clouds. In order to make point clouds usable, compression is necessary. Two compression technologies have been proposed for point cloud compression/coding (PCC) standardization activities: video-based PCC (V-PCC) and geometry-based PCC (G-PCC). V-PCC approach is based on 3D to two-dimensional (2D) projections, while G-PCC, on the contrary, encodes the content directly in 3D space. In order to achieve that, G-PCC utilizes data structures, such as an octree that describes the point locations in 3D space.

### SUMMARY

According to one aspect of the present disclosure, a method of decoding by a decoder is provided. The method may include decoding, by a processor, a first syntax element from a bitstream to determine a base mesh. The method may include decoding, by the processor, a second syntax element from the bitstream to determine whether additional prediction candidates for parallelogram-prediction coding is enabled for the base mesh. The method may include, in response to additional prediction candidates for parallelogram-prediction coding being enabled for the base mesh, decoding, by the processor, a third syntax element from the bitstream to determine a parallelogram-prediction coding mode from among a plurality of parallelogram-prediction coding modes for decoding the bitstream. The method may include decoding, by the processor, a fourth syntax element from the bitstream to determine a position offset associated with the parallelogram-prediction coding mode. The method may include decoding, by the processor, the bitstream based on the parallelogram-prediction coding mode and the position offset.

According to another aspect of the present disclosure, an apparatus for decoding by a decoder. The apparatus may include a processor and memory storing instructions. The memory storing instructions, which when executed by the processor, may cause the processor to decode a first syntax element from a bitstream to determine a base mesh. The memory storing instructions, which when executed by the processor, may cause the processor to decode a second syntax element from the bitstream to determine whether the additional prediction candidates parallelogram-prediction coding is enabled for the base mesh. The memory storing instructions, which when executed by the processor, may cause the processor to, in response to additional prediction candidates parallelogram-prediction coding being enabled for the base mesh, decode a third syntax element from the bitstream to determine a parallelogram-prediction coding mode from among a plurality of parallelogram-prediction coding modes for decoding the bitstream. The memory storing instructions, which when executed by the processor, may cause the processor to decode a fourth syntax element from the bitstream to determine a position offset associated with the parallelogram-prediction coding mode. The memory storing instructions, which when executed by the processor, may cause the processor to decode the bitstream based on the parallelogram-prediction coding mode and the position offset.

According to a further aspect of the present disclosure, a method of encoding by an encoder is provided. The method may include encoding, by a processor, a first syntax element to a bitstream to indicate a base mesh. The method may include encoding, by the processor, a second syntax element to the bitstream to indicate whether additional prediction candidates for parallelogram-prediction coding is enabled for the base mesh. The method may include, in response to additional prediction candidates for parallelogram-prediction coding being enabled for the base mesh, encoding, by the processor, a third syntax element to the bitstream to indicate a parallelogram-prediction coding mode from among a plurality of parallelogram-prediction coding modes used to encode the bitstream. The method may include encoding, by the processor, a fourth syntax element to the bitstream to indicate a position offset associated with the parallelogram-prediction coding mode. The method may include encoding, by the processor, the bitstream based on the parallelogram-prediction coding mode and the position offset.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates a block diagram of a geometry-coding process implemented by an encoder, according to some embodiments of the present disclosure.

FIGS. 6A-6C illustrates a mesh subdivision and mesh displacement approximation process implemented by an encoder, according to some embodiments of the present disclosure.

FIG. 7 illustrates a diagram of displacement-component decomposition in a local-coordinate system, according to some embodiments of the present disclosure.

FIG. 8 illustrates a diagram of an example parallelogram-prediction coding, according to one aspect of the present disclosure.

FIG. 9 illustrates a diagram of a mesh data structure, according to some embodiments of the present disclosure.

FIG. 10 illustrates a diagram of a mesh with four vertices and three triangular faces, according to some embodiments of the present disclosure.

FIG. 11 illustrates a connectivity diagram of a mesh with four vertices and three triangular faces, according to some embodiments of the present disclosure.

FIG. 12 illustrates a data structure diagram for a parametrized mesh, according to some embodiments of the present disclosure.

FIG. 13 illustrates a diagram of a mesh with four vertices, three triangular faces, and a corresponding attribute map, according to some embodiments of the present disclosure.

FIG. 14 illustrates a diagram of mesh-face orientation based on vertex-index order, according to some embodiments of the present disclosure.

FIG. 15 illustrates a diagram of an exemplary parallelogram-prediction coding technique, according to some embodiments of the present disclosure.

FIG. 16 illustrates a flow chart of an exemplary method of encoding by an encoder, according to some embodiments of the present disclosure.

FIG. 17 illustrates a flow chart of an exemplary method of decoding by a decoder, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of point cloud coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system. The techniques described herein may be used for various point cloud coding applications. As described herein, point cloud coding includes both encoding and decoding a point cloud.

A point cloud is composed of a collection of points in a 3D space. Each point in the 3D space is associated with a geometry position together with the associated attribute information (e.g., color, reflectance, intensity, classification, etc.). In order to compress the point cloud data efficiently, the geometry of a point cloud can be compressed first, and then the corresponding attributes, including color or reflectance, can be compressed based upon the geometry information according to a point cloud coding technique, such as G-PCC. G-PCC has been widely used in virtual reality/augmented reality (VR/AR), telecommunication, autonomous vehicle, etc., for entertainment and industrial applications, e.g., light detection and ranging (LiDAR) sweep compression for automotive or robotics and high-definition (HD) map for navigation. Moving Picture Experts Group (MPEG) released the first version G-PCC standard, and Audio Video Coding Standard (AVS) is also developing a G-PCC standard.

The existing G-PCC standards, however, cannot work well for a wide range of PCC inputs for many different applications. For example, besides the representation of levels (or coefficients in some cases), the representation of other information (e.g., parameters) used for G-PCC may be coded in the forms of syntax elements in the bitstream as well. Since G-PCC is organized in different levels by dividing a collection of points into different pieces (e.g., sequence, slices, etc.) associated with different properties (e.g., geometry, attributes, etc.), the parameter sets are also arranged in different levels (e.g., sequence-level, property-level, slice-level, etc.), for example, in the different headers. Moreover, multiple condition checks may be required for parsing some syntax elements in G-PCC, which further increases the complexity of organizing and parsing the representation of syntax elements.

To improve the flexibility and generality of point cloud coding, the present disclosure provides various novel schemes of syntax element representation and organization, which are compatible with any suitable G-PCC standards, including, but not limited to, AVS G-PCC standards and MPEG G-PCC standards.

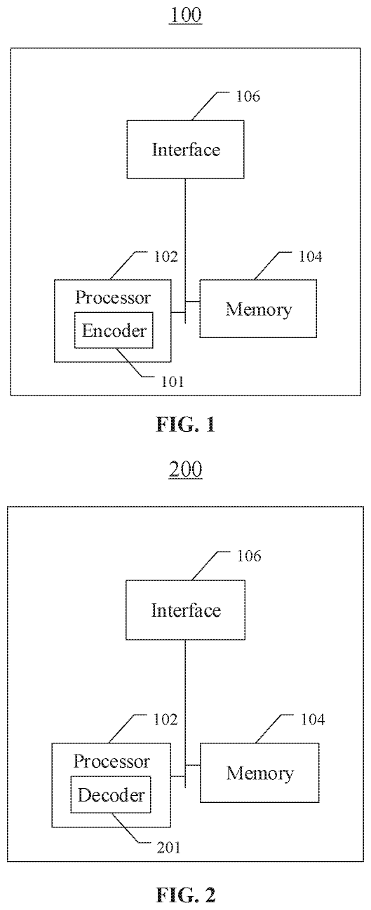

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatuses capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected one to another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing point cloud coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running point cloud encoding and decoding applications. In another example, processor 102, memory 104, and interface 106 may be integrated on a specialized processor chip for point cloud coding, such as a GPU or ISP chip dedicated to graphic processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud encoding, such as voxelization, transformation, quantization, arithmetic encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud decoding, such as arithmetic decoding, dequantization, inverse transformation, reconstruction, synthesis, as described below in detail.

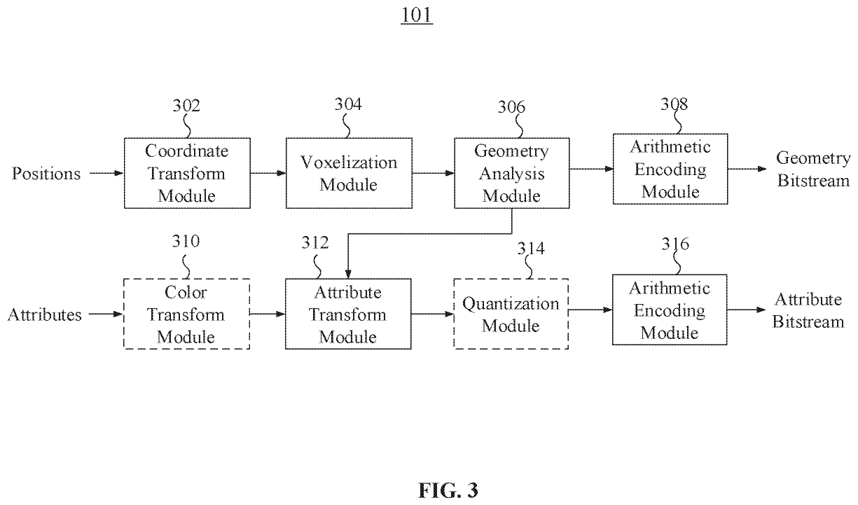

FIG. 3 illustrates a detailed block diagram of exemplary encoder 101 in encoding system 100 in FIG. 1, according to some embodiments of the present disclosure. As shown in FIG. 3, encoder 101 may include a coordinate transform module 302, a voxelization module 304, a geometry analysis module 306, and an arithmetic encoding module 308, together configured to encode positions associated with points of a point cloud into a geometry bitstream (i.e., geometry encoding). As shown in FIG. 3, encoder 101 may also include a color transform module 310, an attribute transform module 312, a quantization module 314, and an arithmetic encoding module 316, together configured to encode attributes associated with points of a point cloud into an attribute bitstream (i.e., attribute encoding). It is understood that each of the elements shown in FIG. 3 is independently shown to represent characteristic functions different from each other in a point cloud encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101. It is still further understood that the modules shown in FIG. 3 are for illustrative purposes only, and in some examples, different modules may be included in encoder 101 for point cloud encoding.

As shown in FIG. 3, geometry positions and attributes associated with points may be encoded separately. A point cloud may be a collection of points with positions Xₖ=(xₖ, yₖ, zₖ), k=1, . . . , K, where K is the number of points in the point cloud, and attributes Aₖ=(A₁ₖ, A₂ₖ, . . . , A_{Dk}), k=1, . . . , K, where D is the number of attributes for each point. In some embodiments, attribute coding depends on decoded geometry. As a consequence, point cloud positions may be coded first. Since geometry positions may be represented by floating-point numbers in an original coordinate system, coordinate transform module 302 and a voxelization module 304 may be configured to perform a coordinate transformation followed by voxelization that quantizes and removes duplicate points. The process of position quantization, duplicate point removal, and assignment of attributes to the remaining points is called voxelization. The voxelized point cloud may be represented using, for example, an octree structure in a lossless manner. Geometry analysis module 306 may be configured to perform geometry analysis using, for example, the octree or trisoup scheme. Arithmetic encoding module 308 may be configured to arithmetically encode the resulting structure from geometry analysis module 306 into the geometry bitstream.

In some embodiments, geometry analysis module 306 is configured to perform geometry analysis using the octree scheme. Under the octree scheme, a cubical axis-aligned bounding box B may be defined by the two extreme points (0,0,0) and (2^{d}, 2^{d}, 2^{d}) where d is the maximum size of the given point cloud along the x, y, or z direction. All point cloud points may be included in this defined cube. A cube may be divided into eight sub-cubes, which creates the octree structure, allowing one parent to have 8 children, and an octree structure may then be built by recursively subdividing sub-cubes. An 8-bit code may be generated by associating a 1-bit value with each sub-cube to indicate whether it contains points (i.e., full and has value 1) or not (i.e., empty and has value 0). Only full sub-cubes with a size greater than 1 (i.e., non-voxels) may be further subdivided. The geometry information (x, y, z) for one position may be represented by this defined octree structure. Since points may be duplicated, multiple points may be mapped to the same sub-cube of size 1 (i.e., the same voxel). In order to handle such a situation, the number of points for each sub-cube of dimension 1 is also arithmetically encoded. By construction of the octree, a current cube associated with a current node may be surrounded by six cubes of the same depth sharing a face with it. Depending on the location of the current cube, one cube may have up to six same-sized cubes to share one face. In addition, the current cube may also have some neighboring cubes that share lines or points with the current cube.

Referring back to FIG. 3, as to attribute encoding, optionally, color transform module 310 may be configured to convert red/green/blue (RGB) color attributes of each point to YCbCr color attributes if the attributes include color. Attribute transform module 312 may be configured to perform attribute transformation based on the results from geometry analysis module 306 (e.g., using the octree scheme), including but not limited to, the region adaptive hierarchical transform (RAHT), interpolation-based hierarchical nearest-neighbor prediction (predicting transform), and interpolation-based hierarchical nearest-neighbor prediction with an update/lifting step (lifting transform). Optionally, quantization module 314 may be configured to quantize the transformed coefficients of attributes from attribute transform module 312 to generate quantization levels of the attributes associated with each point to reduce the dynamic range. Arithmetic encoding module 316 may be configured to arithmetically encode the resulting transformed coefficients of attributes associated with each point or the quantization levels thereof into the attribute bitstream.

In some embodiments, a prediction may be formed from neighboring coded attributes, for example, in predicting transform and lifting transform by attribute transform module 312. Then, the difference between the current attribute and the prediction may be coded. According to some aspects of the present disclosure, in the AVS G-PCC standard, after the geometry positions are coded, a Morton code or Hilbert code may be used to convert a point cloud in a 3D space (e.g., a point cloud cube) into a 1D array. Each position in the cube will have a corresponding Morton or Hilbert code, but some positions may not have any corresponding point cloud attribute. In other words, some positions may be empty. The attribute coding may follow the predefined Morton order or Hilbert order. A predictor may be generated from the previous coded points in the 1D array following the Morton order or Hilbert order. The attribute difference between the current point and its prediction points may be encoded into the bitstream. In some embodiments, the point cloud in the 3D space (e.g., a point cloud cube) is converted into a 1D array without any predefined order, but instead in its native input order, for example, the order in which the point cloud data is collected. That is, in some examples, the attribute coding may follow the native input order of the point cloud, instead of the predefined Morton order or Hilbert order. In other words, the order followed by the points in the 1D array may be either a Morton order, a Hilbert order, or the native input order.

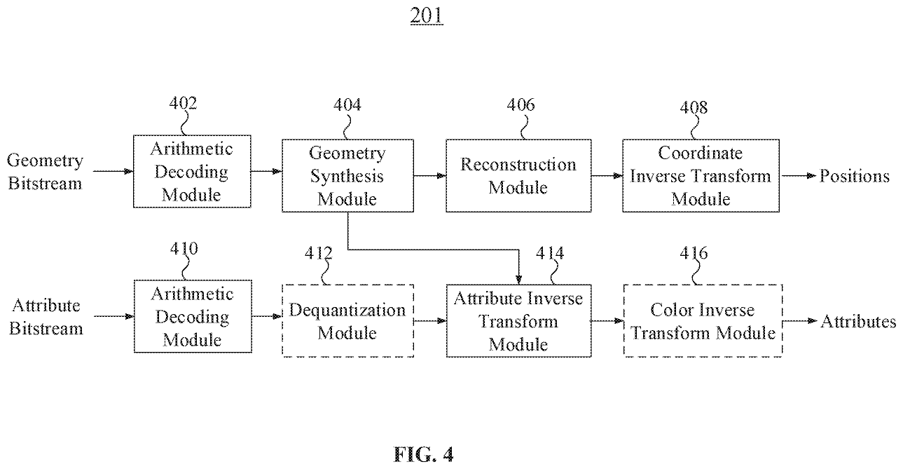

FIG. 4 illustrates a detailed block diagram of exemplary decoder 201 in decoding system 200 in FIG. 2, according to some embodiments of the present disclosure. As shown in FIG. 4, decoder 201 may include an arithmetic decoding module 402, a geometry synthesis module 404, a reconstruction module 406, and a coordinate inverse transform module 408, together configured to decode positions associated with points of a point cloud from the geometry bitstream (i.e., geometry decoding). As shown in FIG. 4, decoder 201 may also include an arithmetic decoding module 410, a dequantization module 412, an attribute inverse transform module 414, and a color inverse transform module 416, together configured to decode attributes associated with points of a point cloud from the attribute bitstream (i.e., attribute decoding). It is understood that each of the elements shown in FIG. 4 is independently shown to represent characteristic functions different from each other in a point cloud decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201. It is still further understood that the modules shown in FIG. 4 are for illustrative purposes only, and in some examples, different modules may be included in decoder 201 for point cloud decoding.

When a point cloud bitstream (e.g., a geometry bitstream or an attribute bitstream) is input from a point cloud encoder (e.g., encoder 101), the input bitstream may be decoded by decoder 201 in a procedure opposite to that of the point cloud encoder. Thus, the details of decoding that are described above with respect to encoding may be skipped for ease of description. Arithmetic decoding modules 402 and 410 may be configured to decode the geometry bitstream and attribute bitstream, respectively, to obtain various information encoded into the bitstream. For example, arithmetic decoding module 410 may decode the attribute bitstream to obtain the attribute information associated with each point, such as the quantization levels or the coefficients of the attributes associated with each point. Optionally, dequantization module 412 may be configured to dequantize the quantization levels of attributes associated with each point to obtain the coefficients of attributes associated with each point. Besides the attribute information, arithmetic decoding module 410 may parse the bitstream to obtain various other information (e.g., in the form of syntax elements), such as the syntax element indicative of the order followed by the points in the 1D array for attribute coding.

Inverse attribute transform module 414 may be configured to perform inverse attribute transformation, such as inverse RAHT, inverse predicting transform, or inverse lifting transform, to transform the data from the transform domain (e.g., coefficients) back to the attribute domain (e.g., luma and/or chroma information for color attributes). Optionally, color inverse transform module 416 may be configured to convert YCbCr color attributes to RGB color attributes.

As to the geometry decoding, geometry synthesis module 404, reconstruction module 406, and coordinate inverse transform module 408 of decoder 201 may be configured to perform the inverse operations of geometry analysis module 306, voxelization module 304, and coordinate transform module 302 of encoder 101, respectively.

Consistent with the scope of the present disclosure, encoder 101 and decoder 201 may be configured to adopt various novel schemes of syntax element representation and organization, as disclosed herein, to improve the flexibility and generality of point cloud coding.

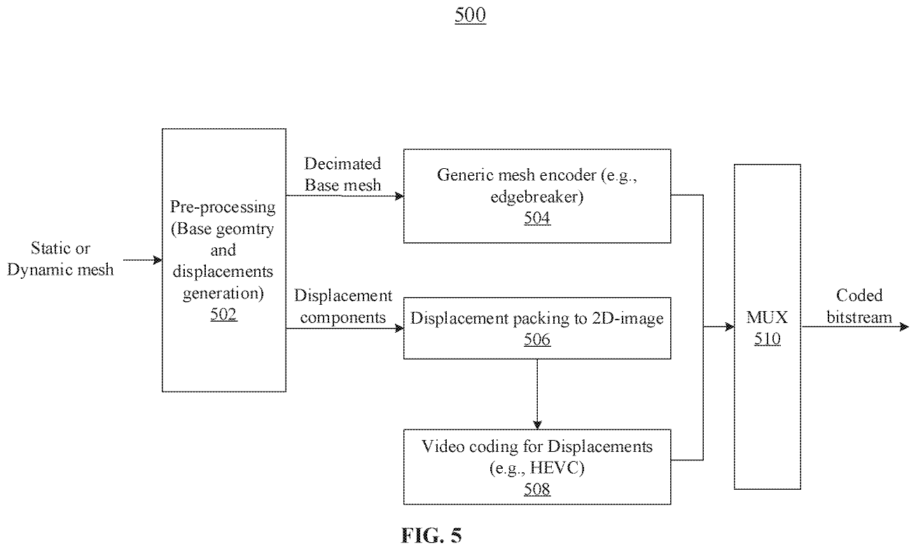

Some existing techniques apply a two-stage encoding procedure to encode geometry information. First, the geometry is decimated to create a base mesh encoded using generic geometry-coding method, e.g., “edgebreaker.” Then, the base mesh is hierarchically subdivided, and the difference between the subdivided point and the approximation of the original mesh is stored as the geometry displacements component. The displacement components are packed into a two-dimensional (2D) image and encoded with lossless video coding. A high-level diagram of the two-stage geometry-coding process 500 is described below in connection with FIG. 5.

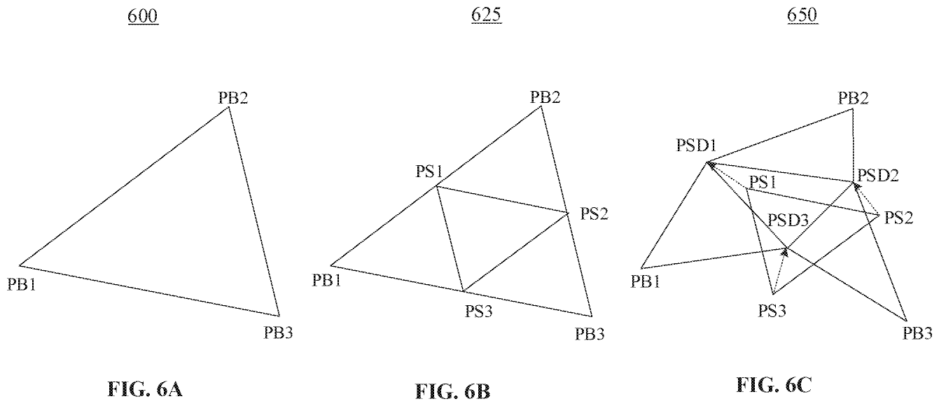

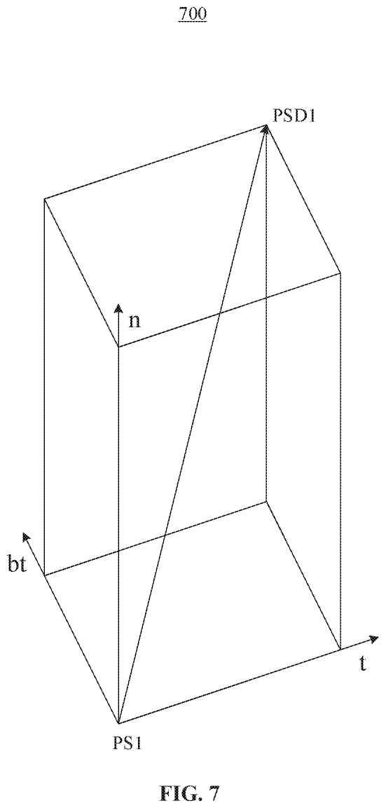

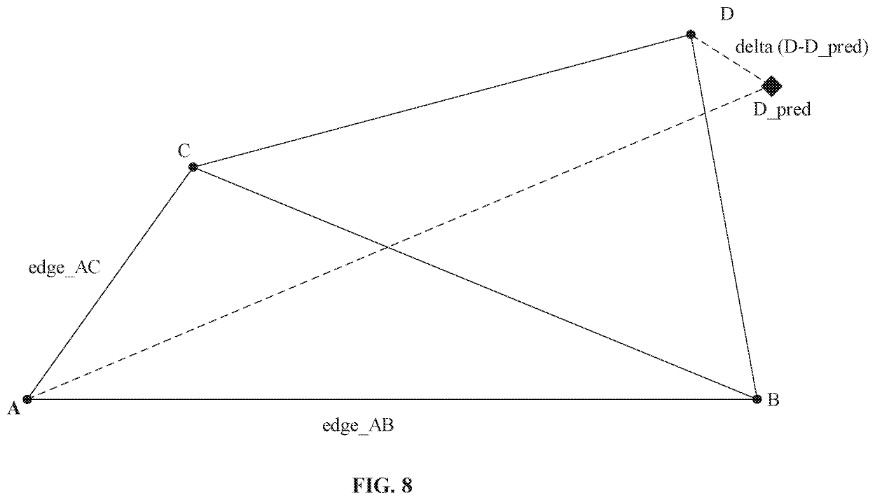

Referring to FIG. 5, an encoder may receive a static or dynamic mesh of a video, picture, frame, scene, etc. At 502, the encoder may perform pre-processing to generate a base-mesh geometry and mesh displacements. The base-mesh geometry may include a decimated base mesh with a fewer number of points than the static or dynamic mesh that was originally received. The decimated base mesh may be input to a mesh encoder 504 that implements, e.g., an edgebreaker encoding process. The mesh encoder may perform geometry encoding of the decimated base mesh. On the other hand, the mesh displacements may be input to a displacements-packing component 506. The displacements-packing component 506 may perform displacements packing to a 2D image, as described below in connection with FIGS. 6A-6C. The displacement packing information may be input to a video coder 508 for displacements, e.g., such as an HEVC component. Mesh encoder 504 and video coder 508 may input their respective information to a multiplexer (MUX) 510, which encodes the information into a bitstream.

FIGS. 6A-6C illustrates a mesh subdivision and mesh displacement approximation process 600, 625, 650 implemented by a displacements-packing component of an encoder, according to some embodiments of the present disclosure. FIG. 7 illustrates a diagram of displacement-component decomposition 700 in a local-coordinate system, according to some embodiments of the present disclosure. In FIGS. 6A-6C, this process is illustrated for once face in a base mesh.

Referring to FIG. 6A, PB1, PB2, and PB3 denote the base mesh points. PS1, PS2, and PS3, in FIG. 6B, represent subdivided points. PSD1, PSD2, and PSD3 represent subdivided displaced points, as shown in FIG. 6C. Subdivided point PS1 may be calculated as a mid-point between the PB1 and PB2 points. Then, the process can be recursively repeated. Referring to FIGS. 6C and 7, each vector of PS1 and PSD1 is described as three components in normal, tangent, and bitangent directions that are further mapped to color planes (e.g., Y, U, and V components in YUV 444 color space).

FIG. 8 illustrates a diagram of an example parallelogram-prediction coding, according to one aspect of the present disclosure.

The base mesh frame is quantized and encoded using a static mesh encoder. The process is agnostic, of which mesh encoding scheme is used to compress the base mesh.

Base mesh vertex positions are coded using a parallelogram prediction model and a differential coding of a real vertex position versus a predicted vertex position, as demonstrated in FIG. 8.

In the method depicted in FIG. 8, given a face ABC and a face BCD to predict the position of a point D, a diagonal of a parallelogram created by as vector addition of edge AC and edge AB to find a vector AD_pred can be used, where D_pred is a predicted position of a point D. Then a difference between point D and point D_pred is coded.

The displacements are processed by a hierarchical wavelet (or another) transform that recursively applies refinement layers to the reconstructed base mesh. The wavelet coefficients are then quantized (e.g., by quantization module 314), packed into a 2D image/video, and can be compressed by encoder 101. The reconstructed version of the wavelet coefficients is obtained by applying image unpacking and inverse quantization (e.g., dequantization module 412) to the reconstructed wavelet coefficient image/video generated during the image/video decoding process. Reconstructed displacements are then computed by applying the inverse wavelet transform (e.g., by attribute inverse transform module 414) to the reconstructed wavelet.

Wavelet-transform coefficients are calculated in a floating-point format and can be positive and/or negative. In existing techniques, the coefficients are first converted to positive values and mapped to a given bit-depth to generate a 2D image, using expression (1).

$$c ’ = 2 ⋀ [ bit\_depth - 1 ] + [ c ( i ) ⋆ 2 ⋀ bit\_depth ] / [ c\_max - c\_min ] , \qquad ( 1 )$$

where c′(i) is an integerized displacement coefficient value, c(i) is a current displacement coefficient, c_max is a maximum displacement coefficient value, c_min is a minimum displacement coefficient value, and bit_depth is a value that defines a number of fixed levels for image coding.

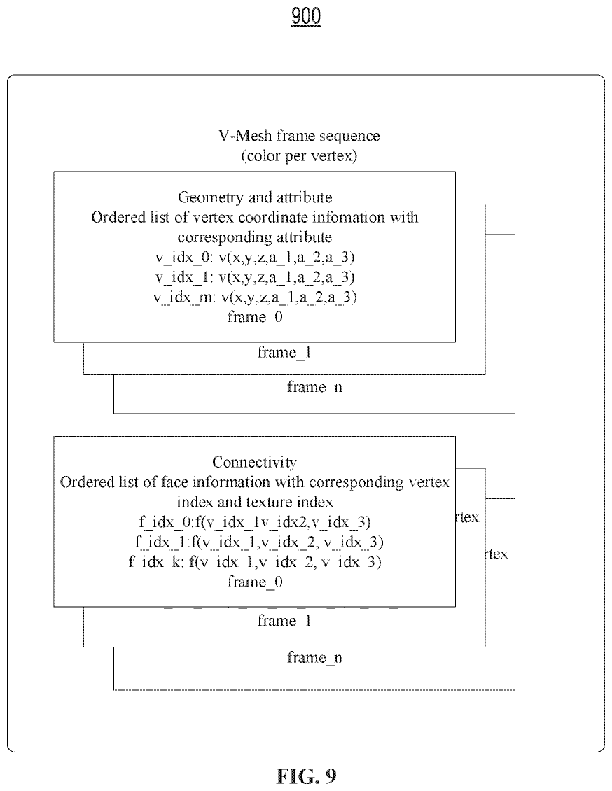

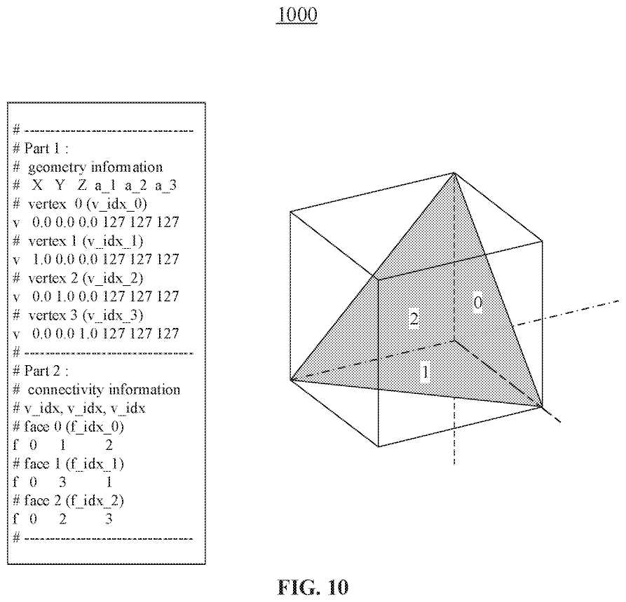

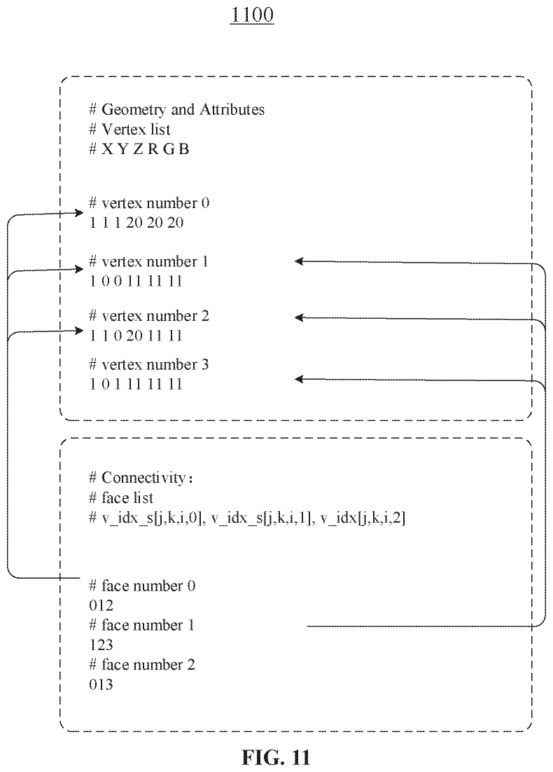

An example of geometry information for one mesh frame is depicted in the mesh data structure 900 illustrated in FIG. 9. FIG. 10 illustrates a diagram 1000 of a mesh with four vertices and three triangular faces, according to some embodiments of the present disclosure. FIG. 11 illustrates a connectivity diagram 1100 of a mesh with four vertices and three triangular faces, according to some embodiments of the present disclosure.

Referring to FIG. 10, an example of a surface, represented by a mesh with color-per-vertex characteristics, four vertices, and three faces. A position in space describes each vertex by X, Y, Z coordinates and color attributes red (R), green (G), and blue (B). As shown in FIG. 10, each face is defined by three vertex indices that form a triangle. A connectivity diagram of these features is illustrated in FIG. 11.

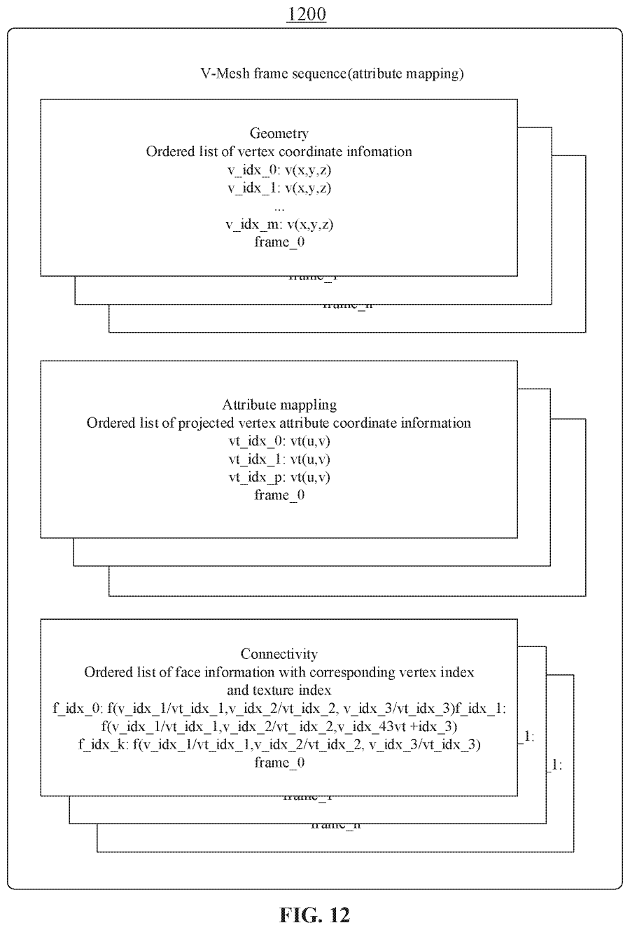

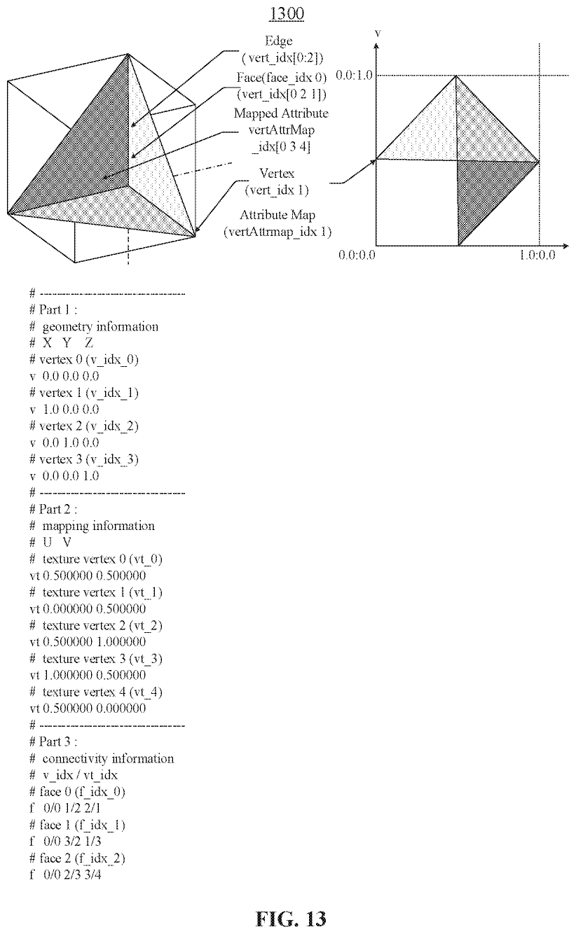

FIG. 12 illustrates a data structure diagram 1200 for a parametrized mesh, according to some embodiments of the present disclosure. FIG. 13 illustrates a diagram 1300 of a mesh with four vertices and three triangular faces and a corresponding attribute map, according to some embodiments of the present disclosure.

An example of a surface, represented by a mesh with attribute mapping characteristics (e.g., FIG. 12) that includes four vertices and three faces is depicted in FIG. 13. A position in space describes each vertex by X, Y, and Z coordinates. U and V denote attribute coordinates in the 2D texture vertex map. Each face is defined by three pairs of vertex indices, texture vertex coordinates that form a triangle in 3D space, and a triangle in the 2D texture map.

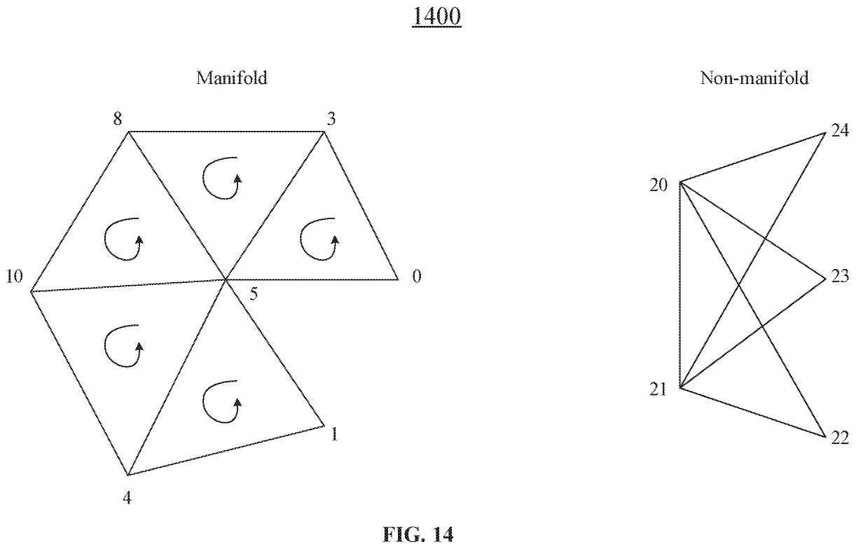

FIG. 14 illustrates a diagram of mesh-face orientation 1400 based on vertex-index order, according to some embodiments of the present disclosure. Referring to FIG. 14, the orientation of the face is determined using the right-hand coordinate system. The face includes three vertices that belong to three edges, and the three vertex indices describe each face. A manifold mesh is a mesh where one edge belongs to two different faces at most, as shown on the left-hand side of FIG. 14. On the other hand, a non-manifold mesh is a mesh with an edge that belongs to more than two faces, as shown on the right-hand side of FIG. 14.

Unfortunately, the example parallelogram-prediction coding described above is only able to predict point D with a high-degree of accuracy when the area of triangle ABC is approximately the same in area as BCD due to the diagonal parallelogram-prediction rule (e.g., the vector addition described above). However, mesh triangles often have different areas due to the nature of mesh parametrization. The less accurate the prediction, the greater the number of bits that are encoded to indicate the position prediction residual.

To overcome these and other challenges, the present disclosure provides an exemplary parallelogram-prediction coding technique that uses a plurality of different prediction modes. Once the plurality of positions for a vertex is predicted by applying each of the parallelogram-prediction coding modes to a triangle of the base mesh, the encoder may select the position that is closest to the vertex's actual position and encode only the offset of the closest prediction and the associated parallelogram-prediction coding mode. In this way, bitstream overhead may be reduced.

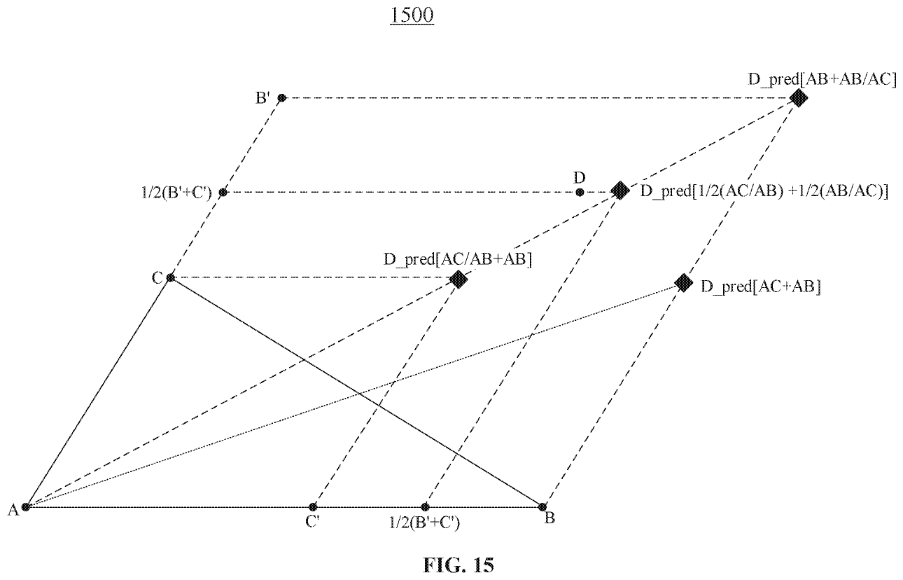

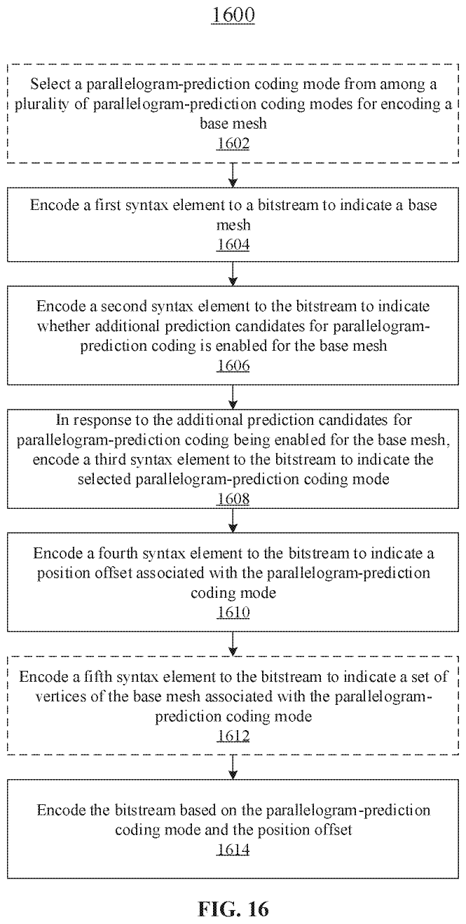

Additional details of the exemplary mesh parallelogram-prediction coding techniques are described below in connection with FIGS. 15 and 16.

FIG. 15 illustrates a diagram of an exemplary parallelogram-prediction coding technique 1500, according to some embodiments of the present disclosure.

Referring to FIG. 15, to encode the positions of the vertex in a base mesh efficiently, the parallelogram-prediction coding technique of the present disclosure introduces additional position candidates to the predicted vertex position list. This can be achieved by normalizing edge AC by the scalar of the norm of the edge AB and edge AB by the scalar of the norm of the edge AC so that the scalar value of the norms of the vectors |AB′|=|AC|, or |AB|=|AC′|. Additionally, both vectors can be normalized over a scalar value of an average |(AB+AC)/2|. Each of the new parallelogram-prediction candidates creates a different coding mode with a fixed length coding (e.g., 2 bits), or variable length coding (e.g., Mode A: 1 (1 bit), Mode B: 010 (3 bits), Mode C: 011, Mode D: 00100 (5 bits), Mode E: 00101, Mode F: 00110, etc.) to indicate a corresponding coding mode. In FIG. 15, AB′ is edge AB normalized to a scalar value of edge AC (e.g., |AB′|=|AC|), AC′ is edge AC normalized to a scalar value of edge AB (e.g., |AB|=|AC′|), A′C′ is edge AC, and edge AB is normalized to a scalar value of an average of edge AB and AC (e.g., |(AB+AC)/2|).

Still referring to FIG. 15, encoder 101 may determine the predicted position of point D (e.g., D_pred) using each of the four parallelogram-prediction coding modes. For example, encoder 101 may determine D_pred[(AC/AB)+AB], D_pred[AC+AB], D_pred[((AC/AB)/2)+((AB/AC)/2)], and D_pred[AB+(AB/AC)]. Then, encoder 101 may determine the D_pred that uses a minimum number of bits to represent a distance between point D and point D_pred, and select the corresponding parallelogram-prediction coding mode for use in encoding the bitstream. In the non-limiting example depicted in FIG. 15, the parallelogram-prediction coding mode for D_pred[((AC/AB)/2)+((AB/AC)/2)] provides the predicted mesh vertex D that is closest in proximity to mesh vertex D. Thus, encoder 101 may select the parallelogram-prediction coding mode encode a syntax element that indicates the parallelogram-prediction coding mode that corresponds to D_pred[((AC/AB)/2)+((AB/AC)/2)] and another syntax element that indicates its associated position offset, as described below.

Table 1 below illustrates exemplary syntax elements that may be encoded into the bitstream to indicate the selected parallelogram-prediction coding mode and the corresponding position offset. For instance, encoder 101 may encode a first syntax element (e.g., sismu_intra_unit_default, mesh_position_coding_payload, etc.) to indicate the vertex positions of a base mesh. If the number of vertices in the base mesh is greater than 0, encoder 101 may encode a second syntax element (e.g., sismu_derived_pos_present_flag, mesh_derived_position_mode, etc.) into the bitstream to indicate whether additional prediction candidate points for parallelogram-prediction coding are enabled for the base mesh. When coding using the additional prediction candidate points for parallelogram-prediction coding is enabled, encoder 101 may encode a third syntax element (e.g., sismu_pos_mode, mesh_position_mode, etc.) to indicate the selected parallelogram-prediction coding mode. As mentioned above, the selected parallelogram-prediction coding mode may be the coding mode that produces the D_pred closest in proximity to the actual position of mesh vertex D. Encoder 101 may encode a fourth syntax element (e.g., sismu_pos_signalled_diff, mesh_position_residual, etc.) to indicate the position offset between D_pred of the selected parallelogram-prediction coding mode and the actual position of mesh vertex D.

TABLE 1
Parallelogram-Coding Mode Syntax Elements

| | Descriptor |
|---|---|
| sismu_intra_unit_default ( subMeshID, vertexCount ) { | |
| if( vertexCount > 0 ) | |
| sismu_derived_pos_present_flag[ subMeshID ] | ae(v) |
| for( i = 0; i < vertexCount ; i++ ) { | |
| if(sismu_derived_pos_present_flag[ subMeshID ]){ | |
| sismu_pos_mode[ subMeshID ][ i ] | u(2) or u(1) |
| } | |
| for ( k = 0; k < numComponents ; k++ ) { | |
| sismu_pos_signalled_diff[ subMeshID ][ i ][ k ] | ae(v) |
| } | |
| ... | |
| } | |

Referring to Table 1, the second syntax element (e.g., sismu_derived_pos_present_flag) indicates additional prediction candidates for paralellogram-prediction coding are enabled when equal to 1 and is the number of paralellogram-prediction coding positions is equal to one and POS_AB is used as predictor when equal to 0. The third syntax element (e.g., sismu_pos_mode) indicates the coding mode for difference coding of a vertex position. The fourth syntax element (e.g., sismu_pos_signalled_diff[k] indicates a difference of a position for a predicted (e.g., D_pred) and the actual mesh vertex position along k-th axis. In Table 1, i is the base mesh vertex and k is the x, y, z coordinate.

When four parallelogram-prediction coding modes are used (e.g., descriptor u(2) in Table 1), the third syntax element may include two bits to indicate the selected coding mode, as shown below in Table 2. Using a single bit in the third syntax element to indicate the parallelogram-prediction coding mode increases precision, but at the cost of an increase in bitstream overhead.

TABLE 2
Third Syntax Element Examples

| sismu_pos_mode | | |
|---|---|---|
| [i] | Identifier | Coding mode |
| 00 | POS_A′B′ | Average Vector |
| 01 | POS_AB | Real Vector |
| 10 | POS_AB′ | Normalized |
| | | vector B |
| 11 | POS_A′B | Normalized |
| | | vector A |

When two parallelogram-prediction coding modes (e.g., average-vector coding mode or real-vector coding mode) are used (e.g., descriptor u(1) in Table 1), the third syntax element may include one bit to indicate the selected coding mode, as shown below in Table 3. Using a single bit in the third syntax element to indicate the parallelogram-prediction coding mode reduces bitstream overhead, but at the cost of precision.

TABLE 3
Third Syntax Element Examples

| sismu_pos_mode | | |
|---|---|---|
| [i] | Identifier | Coding mode |
| 0 | POS_A′B′ | Average Vector |
| 1 | POS_AB | Real Vector |

Referring to Table 4, encoder 101 may indicate whether the parallelogram-prediction coding mode is enabled for a set of base mesh vertices by encoding a fifth syntax element (e.g., sismu_pos_residual_abs_gt0, sismu_pos_residual_sign, sismu_pos_residual_abs_gt1, and sismu_pos_residual_abs_rem) into the bitstream. Coding mode sismu_pos_mode[i] can be adjusted per group or per vertex.

TABLE 5
Fifth Syntax Element Examples

| | Descriptor |
|---|---|
| sismu_intra_unit_default ( subMeshID, vertexCount ) { | |
| ... | |
| groupSize = bmsps_inter_mesh_motion_group_size_minus1 + 1 | |
| groupCount = ( vertexCount − 1) / groupSize + 1 | |
| vStart = 0 | |
| for( g = 0; g < groupCount: g++ ) { | |
| sismu_pos_mode [ subMeshID ][ g ] | u(2) |
| if (g == (groupCount − 1) ) | |
| groupSize = submeshCount− groupSize * (groupCount − 1) | |
| for( v = vStart; v < (vStart+groupSize); v++ ) { | |
| if( sismu_pos_signalled_flag[ subMeshID ][ v ]) { | |
| for( k = 0; k < 3; k++ ) { | |
| sismu_pos_residual_abs_gt0[ subMeshID ][ v ][ k ] | ae(v) |
| if (sismu_mv_residual_abs_gt0[ subMeshID ][ v ][ k ]) { | |
| sismu_pos_residual_sign[ subMeshID ][ v ][ k ] | ae(v) |
| sismu_pos_residual_abs_gt1[ subMeshID ][ v ][ k ] | ae(v) |
| if (sismu_mv_residual_abs_gt1[ subMeshID ][ v ][ k ]) | |
| sismu_pos_residual_abs_rem[ subMeshID ][ v ][ k ] | ae(v) |
| } | |
| } | |
| } | |
| } | |
| vStart += groupSize | |
| } | |
| } | |

FIG. 16 illustrates a flow chart of an exemplary method 1600 of encoding by an encoder, according to some embodiments of the present disclosure. Method 1600 may be performed by encoder 101 of encoding system 100 or any other suitable point cloud decoding systems. Method 1600 may include operations 1602-1614 as described below. It is understood that some of the operations may be optional, and some of the operations may be performed simultaneously, or in a different order other than shown in FIG. 16.

Referring to FIG. 16, at 1602, the encoder may select a parallelogram-prediction coding mode from among a plurality of parallelogram-prediction coding modes for encoding a base mesh. For example, referring to FIG. 15, encoder 101 may determine the predicted position of point D (e.g., D_pred) using each of the four parallelogram-prediction coding modes. For example, encoder 101 may determine D_pred[(AC/AB)+AB], D_pred[AC+AB], D_pred[((AC/AB)/2)+((AB/AC)/2)], and D_pred[AB+(AB/AC)]. Then, encoder 101 may determine the D_pred that uses a minimum number of bits to represent a distance between point D and point D_pred, and select the corresponding parallelogram-prediction coding mode for use in encoding the bitstream.

At 1604, the encoder may encode a first syntax element to a bitstream to indicate a base mesh. For example, referring to Table 2, encoder 101 may encode a first syntax element (e.g., sismu_intra_unit_default) to indicate the vertex positions of a base mesh.

At 1606, the encoder may encode a second syntax element to the bitstream to indicate whether additional prediction candidates for parallelogram-prediction coding is enabled. For example, referring to Table 1, if the number of vertices in the base mesh is greater than 0, encoder 101 may encode a second syntax element (e.g., sismu_derived_pos_present_flag) into the bitstream to indicate whether additional prediction candidates for parallelogram-prediction coding is enabled for the base mesh.

At 1608, in response to the additional prediction candidates for parallelogram-prediction coding being enabled for the base mesh, the encoder may encode a third syntax element to the bitstream to indicate the selected parallelogram-prediction coding mode. For example, referring to Table 1, when the parallelogram-prediction coding is enabled, encoder 101 may encode a third syntax element (e.g., sismu_pos_mode) to indicate the selected parallelogram-prediction coding mode. As mentioned above, the selected parallelogram-prediction coding mode may be the coding mode that produces the D_pred that is most proximate to the actual position of mesh vertex D.

At 1610, the encoder may encode a fourth syntax element to the bitstream to indicate a position offset associated with the parallelogram-prediction coding mode. For example, referring to Table 1, encoder 101 may encode a fourth syntax element (e.g., sismu_pos_signalled_diff) to indicate the position offset between D_pred of the selected parallelogram-prediction coding mode and the actual position of mesh vertex D.

At 1612, the encoder may encode a fifth syntax element to the bitstream to indicate a set of vertices of the base mesh associated with the parallelogram-prediction coding mode. For example, referring to Table 5, encoder 101 may indicate whether the parallelogram-prediction coding mode is enabled for a set of base mesh vertices by encoding a fifth syntax element (e.g., sismu_pos_residual_abs_gt0, sismu_pos_residual_sign, sismu_pos_residual_abs_gt1, and sismu_pos_residual_abs_rem) into the bitstream. Coding mode sismu_pos_mode[i] can be adjusted per group or per vertex.

At 1614, the encoder may encode the bitstream based on the parallelogram-prediction coding mode and the position offset. For example, referring to FIG. 1, encoder 101 may encode the bitstream using the selected parallelogram-prediction coding mode and the position offset.

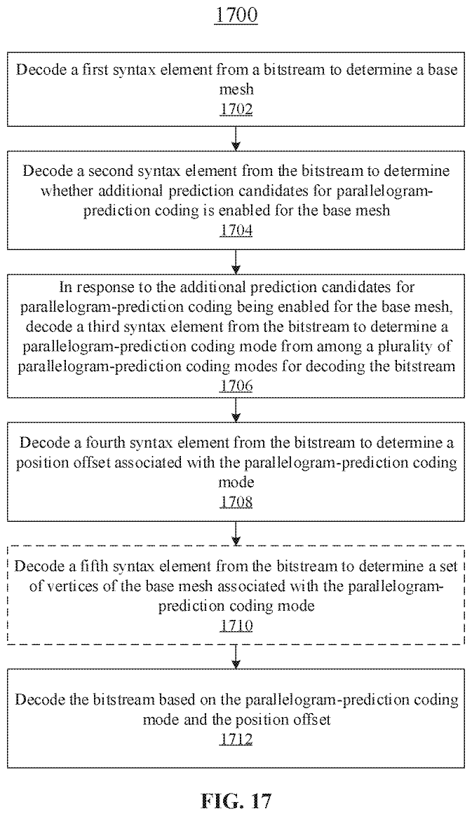

FIG. 17 illustrates a flow chart of an exemplary method 1700 of decoding by a decoder, according to some embodiments of the present disclosure. Method 1700 may be performed by decoder 201 of decoding system 200 or any other suitable decoding systems. Method 1700 may include operations 1702-1712 as described below. It is understood that some of the operations may be optional, and some of the operations may be performed simultaneously, or in a different order other than shown in FIG. 17.

Referring to FIG. 17, at 1702, the decoder may decode a first syntax element from a bitstream to determine a base mesh. For example, referring to Table 2, decoder 201 may decode a first syntax element (e.g., sismu_intra_unit_default) to determine the vertex positions of a base mesh.

At 1704, the decoder may decode a second syntax element from the bitstream to determine whether additional prediction candidates for parallelogram-prediction coding is enabled for the base mesh. For example, referring to Table 1, if the number of vertices in the base mesh is greater than 0, decoder 201 may decode a second syntax element (e.g., sismu_derived_pos_present_flag) from the bitstream to indicate whether additional prediction candidates for parallelogram-prediction coding is enabled for the base mesh.

At 1706, in response to the additional prediction candidates for parallelogram-prediction coding being enabled for the base mesh, the decoder may decode a third syntax element from the bitstream to determine a parallelogram-prediction coding mode from among a plurality of parallelogram-prediction coding modes for decoding the bitstream. For example, referring to Table 1, when the parallelogram-prediction coding is enabled, decoder 201 may decode a third syntax element (e.g., sismu_pos_mode) from the bitstream to determine the selected parallelogram-prediction coding mode. As mentioned above, the selected parallelogram-prediction coding mode may be the coding mode that produces the D_pred that is most proximate to the actual position of mesh vertex D.

At 1708, the decoder may decode a fourth syntax element from the bitstream to determine a position offset associated with the parallelogram-prediction coding mode. For example, referring to Table 1, decoder 201 may decode a fourth syntax element (e.g., sismu_pos_signalled_diff) from the bitstream to determine the position offset between D_pred of the selected parallelogram-prediction coding mode and the actual position of mesh vertex D.

At 1710, the decoder may decode a fifth syntax element from the bitstream to determine a set of vertices of the base mesh associated with the parallelogram-prediction coding mode. For example, referring to Table 5, decoder 201 may determine whether the parallelogram-prediction coding mode is enabled for a set of base mesh vertices by decoding a fifth syntax element (e.g., sismu_pos_residual_abs_gt0, sismu_pos_residual_sign, sismu_pos_residual_abs_gt1, and sismu_pos_residual_abs_rem) from the bitstream. Coding mode sismu_pos_mode[i] can be adjusted per group or per vertex.

At 1712, the decoder may decode the bitstream based on the parallelogram-prediction coding mode and the position offset. For example, referring to FIG. 2, decoder 201 may decode the bitstream based on the parallelogram-prediction coding mode and the corresponding position offset to reconstruct the mesh from the base mesh.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk, where disks usually reproduce data magnetically, while discs reproduce data optically with lasers. Combinations of the above should also be included within the scope of computer-readable media.

According to one aspect of the present disclosure, a method of decoding by a decoder is provided. The method may include decoding, by a processor, a first syntax element from a bitstream to determine a base mesh. The method may include decoding, by the processor, a second syntax element from the bitstream to determine whether additional prediction candidates for parallelogram-prediction coding is enabled for the base mesh. The method may include, in response to additional prediction candidates for parallelogram-prediction coding being enabled for the base mesh, decoding, by the processor, a third syntax element from the bitstream to determine a parallelogram-prediction coding mode from among a plurality of parallelogram-prediction coding modes for decoding the bitstream. The method may include decoding, by the processor, a fourth syntax element from the bitstream to determine a position offset associated with the parallelogram-prediction coding mode. The method may include decoding, by the processor, the bitstream based on the parallelogram-prediction coding mode and the position offset.

In some implementations, the base mesh may include a plurality of vertices that form at least one mesh face). In some implementations, the decoding, by the processor, the bitstream based on the parallelogram-prediction coding mode and the position offset may include calculating an initial position of a mesh vertex based on the at least one mesh face of the base mesh and the parallelogram-prediction coding mode. In some implementations, the decoding, by the processor, the bitstream based on the parallelogram-prediction coding mode and the position offset may include calculating a final position of the mesh vertex based on the initial position and the position offset.

In some implementations, when the plurality of parallelogram-prediction coding modes includes more than two coding modes, the third syntax element may include two bits or variable length coding.

In some implementations, the decoding, by the processor, the bitstream based on the parallelogram-prediction coding mode and the position offset may include the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, the decoding, by the processor, the bitstream based on the parallelogram-prediction coding mode and the position offset may include, when the plurality of parallelogram-prediction coding modes includes two coding modes, the third syntax element may include a single bit.

In some implementations, the plurality of parallelogram-prediction coding modes may include an average-vector coding mode, or a real-vector coding mode.

In some implementations, the method may include decoding, by the processor, a fifth syntax element from the bitstream to determine a set of vertices of the base mesh associated with the parallelogram-prediction coding mode.

According to another aspect of the present disclosure, an apparatus for decoding by a decoder. The apparatus may include a processor and memory storing instructions. The memory storing instructions, which when executed by the processor, may cause the processor to decode a first syntax element from a bitstream to determine a base mesh. The memory storing instructions, which when executed by the processor, may cause the processor to decode a second syntax element from the bitstream to determine whether the additional prediction candidates parallelogram-prediction coding is enabled for the base mesh. The memory storing instructions, which when executed by the processor, may cause the processor to, in response to additional prediction candidates parallelogram-prediction coding being enabled for the base mesh, decode a third syntax element from the bitstream to determine a parallelogram-prediction coding mode from among a plurality of parallelogram-prediction coding modes for decoding the bitstream. The memory storing instructions, which when executed by the processor, may cause the processor to decode a fourth syntax element from the bitstream to determine a position offset associated with the parallelogram-prediction coding mode. The memory storing instructions, which when executed by the processor, may cause the processor to decode the bitstream based on the parallelogram-prediction coding mode and the position offset.

In some implementations, the base mesh may include a plurality of vertices that form at least one mesh face. In some implementations, to decode the bitstream based on the parallelogram-prediction coding mode and the position offset, the memory storing instructions, which when executed by the processor, cause the processor to calculate an initial position of a mesh vertex based on the at least one mesh face of the base mesh and the parallelogram-prediction coding mode. In some implementations, to decode the bitstream based on the parallelogram-prediction coding mode and the position offset, the memory storing instructions, which when executed by the processor, cause the processor to calculate a final position of the mesh vertex based on the initial position and the position offset.

In some implementations, when the plurality of parallelogram-prediction coding modes include more than two coding modes, the third syntax element includes two bits or variable length coding.

In some implementations, the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, when the plurality of parallelogram-prediction coding modes includes two coding modes, the third syntax element may include a single bit.

In some implementations, the plurality of parallelogram-prediction coding modes may include an average-vector coding mode, or a real-vector coding mode.

In some implementations, the memory storing instructions, which when executed by the processor, may further cause the processor to decode a fifth syntax element from the bitstream to determine a set of vertices of the base mesh associated with the parallelogram-prediction coding mode.

According to a further aspect of the present disclosure, a non-transitory computer-readable medium storing instructions is provided. The instructions, which when executed by a processor of a decoder, may cause the processor of the decoder to decode a first syntax element from a bitstream to determine a base mesh. The instructions, which when executed by a processor of a decoder, may cause the processor of the decoder to decode a second syntax element from the bitstream to determine whether additional prediction candidates for parallelogram-prediction coding is enabled for the base mesh. The instructions, which when executed by a processor of a decoder, may cause the processor of the decoder to, in response to additional prediction candidates for parallelogram-prediction coding being enabled for the base mesh, decode a third syntax element from the bitstream to determine a parallelogram-prediction coding mode from among a plurality of parallelogram-prediction coding modes for decoding the bitstream. The instructions, which when executed by a processor of a decoder, may cause the processor of the decoder to decode a fourth syntax element from the bitstream to determine a position offset associated with the parallelogram-prediction coding mode. The instructions, which when executed by a processor of a decoder, may cause the processor of the decoder to decode the bitstream based on the parallelogram-prediction coding mode and the position offset.

In some implementations, the base mesh may include a plurality of vertices that form at least one mesh face. In some implementations, to decode the bitstream based on the parallelogram-prediction coding mode and the position offset, the instructions, which when executed by the processor of the decoder, may cause the processor of the decoder to calculate an initial position of a mesh vertex based on the at least one mesh face of the base mesh and the parallelogram-prediction coding mode. In some implementations, to decode the bitstream based on the parallelogram-prediction coding mode and the position offset, the instructions, which when executed by the processor of the decoder, may cause the processor of the decoder to calculate a final position of the mesh vertex based on the initial position and the position offset.

In some implementations, when the plurality of parallelogram-prediction coding modes may include more than two coding modes, the third syntax element includes two bits or variable length coding.

In some implementations, the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, when the plurality of parallelogram-prediction coding modes includes two coding modes, the third syntax element may include a single bit.

In some implementations, the plurality of parallelogram-prediction coding modes may include an average-vector coding mode, or a real-vector coding mode.

According to still another aspect of the present disclosure, a method of encoding by an encoder is provided. The method may include encoding, by a processor, a first syntax element to a bitstream to indicate a base mesh. The method may include encoding, by the processor, a second syntax element to the bitstream to indicate whether additional prediction candidates for parallelogram-prediction coding is enabled for the base mesh. The method may include, in response to additional prediction candidates for parallelogram-prediction coding being enabled for the base mesh, encoding, by the processor, a third syntax element to the bitstream to indicate a parallelogram-prediction coding mode from among a plurality of parallelogram-prediction coding modes used to encode the bitstream. The method may include encoding, by the processor, a fourth syntax element to the bitstream to indicate a position offset associated with the parallelogram-prediction coding mode. The method may include encoding, by the processor, the bitstream based on the parallelogram-prediction coding mode and the position offset.

In some implementations, the base mesh includes a plurality of vertices that form at least one mesh face. In some implementations, the encoding, by the processor, the bitstream based on the parallelogram-prediction coding mode and the position offset may include calculating an initial position of a mesh vertex based on the at least one mesh face of the base mesh and the parallelogram-prediction coding mode. In some implementations, the encoding, by the processor, the bitstream based on the parallelogram-prediction coding mode and the position offset may include calculating a final position of the mesh vertex based on the initial position and the position offset.

In some implementations, when the plurality of parallelogram-prediction coding modes includes more than two coding modes, the third syntax element may include two bits or variable length coding.

In some implementations, the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, when the plurality of parallelogram-prediction coding modes includes two coding modes, the third syntax element may include a single bit.

In some implementations, the plurality of parallelogram-prediction coding modes may include an average-vector coding mode, or a real-vector coding mode.

In some implementations, the method may include encoding, by the processor, a fifth syntax element to the bitstream to indicate a set of vertices of the base mesh associated with the parallelogram-prediction coding mode.

According to still a further aspect of the present disclosure, an apparatus for encoding by an encoder is provided. The apparatus may include a processor, and memory storing instructions. The memory storing instructions, which when executed by the processor, may cause the processor to encode a first syntax element to a bitstream to indicate a base mesh. The memory storing instructions, which when executed by the processor, may cause the processor to encode a second syntax element to the bitstream to indicate whether additional prediction candidates for parallelogram-prediction coding is enabled for the base mesh. The memory storing instructions, which when executed by the processor, may cause the processor to, in response to additional prediction candidates for parallelogram-prediction coding being enabled for the base mesh, encode a third syntax element to the bitstream to indicate a parallelogram-prediction coding mode from among a plurality of parallelogram-prediction coding modes used to encode the bitstream. The memory storing instructions, which when executed by the processor, may cause the processor to encode a fourth syntax element to the bitstream to indicate a position offset associated with the parallelogram-prediction coding mode. The memory storing instructions, which when executed by the processor, may cause the processor to encode the bitstream based on the parallelogram-prediction coding mode and the position offset.

In some implementations, the base mesh may include a plurality of vertices that form at least one mesh face. In some implementations, to encode the bitstream based on the parallelogram-prediction coding mode and the position offset, the memory storing instructions, which when executed by the processor, may cause the processor to calculate an initial position of a mesh vertex based on the at least one mesh face of the base mesh and the parallelogram-prediction coding mode. In some implementations, to encode the bitstream based on the parallelogram-prediction coding mode and the position offset, the memory storing instructions, which when executed by the processor, may cause the processor to calculate a final position of the mesh vertex based on the initial position and the position offset.

In some implementations, when the plurality of parallelogram-prediction coding modes includes more than two coding modes, the third syntax element may include two bits or variable length coding.

In some implementations, the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, when the plurality of parallelogram-prediction coding modes include two coding modes, the third syntax element may include a single bit.

In some implementations, the plurality of parallelogram-prediction coding modes include an average-vector coding mode, or a real-vector coding mode.

In some implementations, the memory storing instructions, which when executed by the processor, may further cause the processor to encode a fifth syntax element to the bitstream to indicate a set of vertices of the base mesh associated with the parallelogram-prediction coding mode.

According to yet another aspect of the present disclosure, a non-transitory computer-readable medium storing instructions is provided. The instructions, which when executed by a processor of an encoder, may cause the processor of the encoder to encode a first syntax element to a bitstream to indicate a base mesh. The instructions, which when executed by a processor of an encoder, may cause the processor of the encoder to encode a second syntax element to the bitstream to indicate whether additional prediction candidates for parallelogram-prediction coding is enabled for the base mesh. The instructions, which when executed by a processor of an encoder, may cause the processor of the encoder to, in response to additional prediction candidates for parallelogram-prediction coding being enabled for the base mesh, encode a third syntax element to the bitstream to indicate a parallelogram-prediction coding mode from among a plurality of parallelogram-prediction coding modes used to encode the bitstream. The instructions, which when executed by a processor of an encoder, may cause the processor of the encoder to encode a fourth syntax element to the bitstream to indicate a position offset associated with the parallelogram-prediction coding mode. The instructions, which when executed by a processor of an encoder, may cause the processor of the encoder to encode the bitstream based on the parallelogram-prediction coding mode and the position offset.

In some implementations, the base mesh may include a plurality of vertices that form at least one mesh face. In some implementations, to encode the bitstream based on the parallelogram-prediction coding mode and the position offset, the instructions, which when executed by the processor of the encoder, may cause the processor of the encoder to calculate an initial position of a mesh vertex based on the at least one mesh face of the base mesh and the parallelogram-prediction coding mode. In some implementations, to encode the bitstream based on the parallelogram-prediction coding mode and the position offset, the instructions, which when executed by the processor of the encoder, may cause the processor of the encoder to calculate a final position of the mesh vertex based on the initial position and the position offset.

In some implementations, when the plurality of parallelogram-prediction coding modes includes more than two coding modes, the third syntax element may include two bits or variable length coding.

In some implementations, the plurality of parallelogram-prediction coding modes may include an average-vector coding mode, a real-vector coding mode, a first normalized-vector coding mode associated with a first base-mesh face edge, or a second normalized-vector coding mode associated with a second base-mesh face edge different than the first base-mesh face edge.

In some implementations, when the plurality of parallelogram-prediction coding modes includes two coding modes, the third syntax element may include a single bit.

In some implementations, the plurality of parallelogram-prediction coding modes may include an average-vector coding mode, or a real-vector coding mode.

In some implementations, the instructions, which when executed by the processor of the encoder, may further cause the processor of the encoder to encode a fifth syntax element to the bitstream to indicate a set of vertices of the base mesh associated with the parallelogram-prediction coding mode.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
decoding, by a processor, a first syntax element from a bitstream to determine a base mesh;
decoding, by the processor, a second syntax element from the bitstream to determine whether additional prediction candidates for parallelogram-prediction coding is enabled for the base mesh;
in response to the additional prediction candidates for parallelogram-prediction coding being enabled for the base mesh, decoding, by the processor, a third syntax element from the bitstream to determine a parallelogram-prediction coding mode from among a plurality of parallelogram-prediction coding modes for decoding the bitstream;
decoding, by the processor, a fourth syntax element from the bitstream to determine a position offset associated with the parallelogram-prediction coding mode; and
decoding, by the processor, the bitstream based on the parallelogram-prediction coding mode and the position offset.

2. The method of claim 1, wherein:
The base mesh includes a plurality of vertices that form at least one mesh face, and
the decoding, by the processor, the bitstream based on the parallelogram-prediction coding mode and the position offset comprises:
calculating an initial position of a mesh vertex based on the at least one mesh face of the base mesh and the parallelogram-prediction coding mode; and
calculating a final position of the mesh vertex based on the initial position and the position offset.

3. The method of claim 1, wherein, when the plurality of parallelogram-prediction coding modes comprise more than two coding modes, the third syntax element includes two bits or variable length coding.

4. The method of claim 3, wherein the plurality of parallelogram-prediction coding modes comprises:
an average-vector coding mode,
a real-vector coding mode,
a first normalized-vector coding mode associated with a first base-mesh face edge, or
a second normalized-vector coding mode associated with a second base-mesh face edge different than the first base-mesh face edge.

5. The method of claim 1, wherein, when the plurality of parallelogram-prediction coding modes comprise two coding modes, the third syntax element includes a single bit.

6. The method of claim 5, wherein the plurality of parallelogram-prediction coding modes comprises:
an average-vector coding mode, or
a real-vector coding mode.

7. The method of claim 1, further comprising:
decoding, by the processor, a fifth syntax element from the bitstream to determine a set of vertices of the base mesh associated with the parallelogram-prediction coding mode.

8. An apparatus for decoding by a decoder, comprising:
a processor; and
memory storing instructions, which when executed by the processor, cause the processor to:
decode a first syntax element from a bitstream to determine a base mesh;
decode a second syntax element from the bitstream to determine whether additional prediction candidates for parallelogram-prediction coding is enabled for the base mesh;
in response to the additional prediction candidates for parallelogram-prediction coding being enabled for the base mesh, decode a third syntax element from the bitstream to determine a parallelogram-prediction coding mode from among a plurality of parallelogram-prediction coding modes for decoding the bitstream;
decode a fourth syntax element from the bitstream to determine a position offset associated with the parallelogram-prediction coding mode; and
decode the bitstream based on the parallelogram-prediction coding mode and the position offset.

9. The apparatus of claim 8, wherein:
the base mesh includes a plurality of vertices that form at least one mesh face, and
to decode the bitstream based on the parallelogram-prediction coding mode and the position offset, the memory storing instructions, which when executed by the processor, cause the processor to:
calculate an initial position of a mesh vertex based on the at least one mesh face of the base mesh and the parallelogram-prediction coding mode; and
calculate a final position of the mesh vertex based on the initial position and the position offset.

10. The apparatus of claim 8, wherein, when the plurality of parallelogram-prediction coding modes comprise more than two coding modes, the third syntax element includes two bits or variable length coding.

11. The apparatus of claim 10, wherein the plurality of parallelogram-prediction coding modes comprises:
an average-vector coding mode,
a real-vector coding mode,
a first normalized-vector coding mode associated with a first base-mesh face edge, or
a second normalized-vector coding mode associated with a second base-mesh face edge different than the first base-mesh face edge.

12. The apparatus of claim 8, wherein, when the plurality of parallelogram-prediction coding modes comprise two coding modes, the third syntax element includes a single bit.

13. A method of encoding by an encoder, comprising:
encoding, by a processor, a first syntax element to a bitstream to indicate a base mesh;
encoding, by the processor, a second syntax element to the bitstream to indicate whether additional prediction candidates for parallelogram-prediction coding is enabled for the base mesh;
in response to the additional prediction candidates for parallelogram-prediction coding being enabled for the base mesh, encoding, by the processor, a third syntax element to the bitstream to indicate a parallelogram-prediction coding mode from among a plurality of parallelogram-prediction coding modes used to encode the bitstream;
encoding, by the processor, a fourth syntax element to the bitstream to indicate a position offset associated with the parallelogram-prediction coding mode; and
encoding, by the processor, the bitstream based on the parallelogram-prediction coding mode and the position offset.

14. The method of claim 13, wherein:
the base mesh includes a plurality of vertices that form at least one mesh face, and
the encoding, by the processor, the bitstream based on the parallelogram-prediction coding mode and the position offset comprises:
calculating an initial position of a mesh vertex based on the at least one mesh face of the base mesh and the parallelogram-prediction coding mode; and
calculating a final position of the mesh vertex based on the initial position and the position offset.

15. The method of claim 13, wherein, when the plurality of parallelogram-prediction coding modes comprise more than two coding modes, the third syntax element includes two bits or variable length coding.

16. The method of claim 15, wherein the plurality of parallelogram-prediction coding modes comprises:
an average-vector coding mode,
a real-vector coding mode,
a first normalized-vector coding mode associated with a first base-mesh face edge, or
a second normalized-vector coding mode associated with a second base-mesh face edge different than the first base-mesh face edge.

17. The method of claim 13, wherein, when the plurality of parallelogram-prediction coding modes comprise two coding modes, the third syntax element includes a single bit.

18. The method of claim 17, wherein the plurality of parallelogram-prediction coding modes comprises:
an average-vector coding mode, or
a real-vector coding mode.

19. The method of claim 13, further comprising:
encoding, by the processor, a fifth syntax element to the bitstream to indicate a set of vertices of the base mesh associated with the parallelogram-prediction coding mode.

20. A non-transitory computer-readable medium, having instructions and a bitstream stored thereon, wherein the instructions, when executed by a processor of an encoder, cause the processor of the encoder to perform the steps of the method of encoding of claim 13 to generate the bitstream.
